(19) United States
(12) Patent Application Publication
(10) Pub. No.: US 2016/0029076 A1
(43) Pub. Date: Jan. 28, 2016

(54) Arrangements and Method Thereof for Channel Change during Streaming

(71) Applicant: TELEFONAKTIEBOLAGET L M ERICSSON (PUBL), Stockholm (SE)

(72) Inventors: Michael Huber, Taby (SE); Chris Chalkitis, Märsta (SE); Johan Kölhi, Vaxholm (SE); Andreas Ljunggren, Vällingby (SE); Rickard Sjöberg, Stockholm (SE); Jacob Ström, Stockholm (SE)

(21) Appl. No.: 14/772,273

(22) PCT Filed: Mar. 13, 2013
(86) PCT No.: PCT/SE2013/050229

§ 371 Date: Sep. 2, 2015

(51) Int. Cl. H04N 21/438; H04N 21/2343; H04N 21/234; G11B 27/10; G11B 27/036; G11B 27/031; H04N 21/2187; H04N 21/845

(52) U.S. Cl. CPC H04N 21/4384; H04N 21/2187; H04N 21/2343; H04N 21/8456; G11B 27/10; G11B 27/036; G11B 27/031; H04N 21/23424

(57) ABSTRACT

According to embodiments of the present invention, the user-to-user delay and the zapping delay are reduced by a network element which is configured to provide at least one segment that is a shorter version of the actual segment and where the shorter version of the actual segment begins with a key frame or contains key frames only. By providing the at least one segment being a shorter version of the actual segment, wherein a key frame is inserted in the beginning of the segment, the delay, when zapping to a new channel, can be reduced, since a key frame will be accessible with a reduced time delay. Further the user-to-user delay is also reduced since the segment to be joined is shorter. Hence, the time difference occurring when a first user joins in the beginning of a segment and when another user joins at the end of the segment is reduced when the segments are shorter. In addition, the length of the segments can be adjusted to the requested joining point in order to further reduce the user-to-user delay to substantially zero.

### TECHNICAL FIELD

The embodiments relate to media streaming and in particular to channel change during media streaming.

### BACKGROUND

Streaming or media streaming is a technique for transferring data so that it can be processed as a steady and continuous stream. Hence, streaming media is multimedia (e.g. audio and/or video) that is constantly received by and presented to an end-user while being delivered by a provider. “Stream”, refers to the process of delivering media in this manner; the term refers to the delivery method of the medium rather than the medium itself.

By using streaming, the client (browser) can start displaying the received media data before the entire file has been transmitted. However, if the streaming client receives the media data more quickly than required, it needs to save the excess media data in a buffer. When the media data to be streamed comprises video pictures, the video pictures can be encoded as P, B, I frames.
I-frames are the least compressible but don't require other video frames to decode and are also referred to as key frames. In order to be able to start decoding a key frame is required.
P-frames requires data from previous frames to be decodable.
B-frames requires previous and/or forward frames to be decodable.

It should be noted that P- and B-frames can be compressed to a much larger extent than the key frames.

Adaptive bitrate streaming is used for multimedia streaming. Many adaptive streaming technologies are based on HTTP (Hypertext transfer protocol) and designed to work efficiently over large distributed HTTP networks such as the Internet.

Adaptive bitrate streaming works by detecting a user's bandwidth and/or other relevant parameters such as CPU capacity, hardware decoding capacity etc in real time and adjusting the quality of a video stream accordingly. It requires the use of an encoder which can encode a single source video at multiple bit rates. The player client switches between streaming the different encodings depending on available resources. This results in little buffering, fast start time and a good experience for both high-end and low-end connections.

An example of an implementation is adaptive bitrate streaming over HTTP where the source content is encoded at multiple bit rates, then each of the different bit rate streams are segmented into small multi-second parts. This is illustrated in FIG. 1. The streaming client is made aware of the available streams at differing bit rates, and segments of the streams by a manifest file.

When starting the client requests the segments from the lowest bit rate stream. If the client finds the download speed is greater than the bit rate of the segment downloaded, then it will request the next higher bit rate segments. Later, if the client finds the download speed for a segment is lower than the bit rate for the segment, and therefore the network throughput has deteriorated, then it will request a lower bit rate segment. The segment size can vary depending on the particular implementation, but they are typically between two and ten seconds.

When changing from a first channel (i.e. a first stream) to a second channel (i.e. a second stream), the client must await a key frame in order to be able to decode the second channel.

For example, in the DASH (Dynamic Adaptive Streaming) standard, there can be 5 seconds segments in different bitrates, where each segment starts with a key frame (i.e. an I frame) and the following frames are P- or B-frames.

That can be exemplified by:

NormalA: 5-seconds@2 Mbit/s=10 Mbit

NormalB: 5-seconds@1 Mbit/s=5 Mbit

NormalC: 5-seconds@0.5 Mbit/s=2.5 Mbit

NormalD: 5-seconds@0.25 Mbit/s=1.25 Mbit

An intune track is also provided, which comprises multiple I-frames, e.g. one I-frame per second. The intune track can be provided in different bitrates.

Assume that the intune track is only provided in the lowest bitrate:

IntuneD: 5-seconds@0.25 Mbit/s=1.25 Mbit

The “IntuneD” has many I-frames which results in that the quality is lower than for NormalD even though they have the same bitrate. There is also a manifest file which provides information on the different available files including the position of the I-frames.

Thus, the manifest file can include the following information:

IntuneD: Iframes: 0 bits (0 s), 250000 bits (1 s), 500000 bits (2 s),

750000 bits (3 s), 1000000 bits (4 s)

If a user wants to join a channel at t=3.75 seconds. The user performs a http-get on the manifest file and then gets information that there is an Intune file, IntuneD. The user then performs a http get on IntuneD but with a bit range of 1000000-1250000. That implies that the user will only get the last second of the file. The user will suffer from a 0.25 seconds delay. Although the amount of data is exemplified in the number of bits in this example, it should be noted that the manifest file usually defined the amount of data in bytes.

However, this procedure requires functionality by the client.

### SUMMARY

As mentioned above, the DASH solution for the channel change requires functionality by the clients. Thus a major drawback with solutions that require intelligence by the clients is that all clients must be upgraded when a new feature is to be introduced. It is therefore desired to provide a solution improving channel change in the network which is transparent to the clients.

The embodiments of the present invention relate to streaming video and in particular to zapping between different channels. The media data to be streamed is divided into segments, wherein each segment normally is between two to ten seconds. Each segment comprises one self contained key frame in the beginning of the segment followed by non self-contained frames such as P- or B-frames. Since the users can join (zapping to a certain channel) at different time instants and each user has to await a key frame of the segment to be able to decode the segment, the user will suffer from a time delay which may vary between the users.

An object with embodiments is to reduce the zapping delay while also being able to reduce the user-to-user delay caused by the channel change.

This achieved by providing from a network node a new version of the actual segment which is a shorter version of the actual segments wherein a key frame is inserted in the beginning of said segment which is a shorter version of the actual segment.

According to a first aspect of the embodiments, a method to be performed by a network element for enabling streaming of media data is provided. The media data is originally divided into segments of a first length provided in a stream and the media data is represented by non self contained frames and self contained key frames in the segments. In the method, a request for media data of a stream is received from a client. A segment of the requested stream is provided to the client, wherein the segment is a shorter version of the segment that the stream originally was divided in and a first frame of the provided segment is a self contained key frame, and a subsequent segment of the requested stream is provided to the client wherein the subsequent segment is a segment that the stream originally was divided in.

According to a second aspect of the embodiments, a network element for enabling streaming of media data is provided. The media data is originally divided into segments of a first length provided in a stream and the media data is represented by non self contained frames and self contained key frames in the segments. The network element comprises an input unit configured to receive a request for media data of a stream, and an output unit configured to provide a segment of the requested stream, wherein the segment is a shorter version of the segment that the stream originally was divided in and a first frame of the provided segment is a self contained key frame. The output unit is further configured to provide a subsequent segment of the requested stream wherein the subsequent segment is a segment that the stream originally was divided in.

According to a third aspect of the embodiments, a computer program for enabling streaming of media data is provided. Said computer program comprises code means which when run on a computer causes said computer to receive, from a client, a request for media data of a stream, provide, to the client, a segment of the requested stream, wherein the segment is a shorter version of the segment that the stream originally was divided in and a first frame of the provided segment is a self contained key frame, and to provide, to the client, a subsequent segment of the requested stream wherein the subsequent segment is a segment that the stream originally was divided in.

According to a fourth aspect of the embodiments, a computer program product is provided comprising computer readable code means and a computer program as defined above stored on said computer readable code means.

An advantage with the embodiments of the present invention is that user-to-user delay is reduced without introducing a zapping delay.

A further advantage with embodiments is that the length of the shorter segments can be adapted to the requested joining time, since it does not matter if the first shorter segment is created to be very short since it is only the first segment that is shorter. I.e. the disadvantages associated with having shorter segments will not affect the present solution since, it is only the first segment that is shorter.

### BRIEF DESCRIPTION OF THE DRAWINGS

FIG. 1 illustrates adaptive bit rate streaming according to prior art.

FIG. 2 illustrates schematically the segments being a shorter version of the segment that the stream originally was divided in according to embodiments of the present invention.

FIG. 3 illustrates schematically the segments being a shorter version of the segment that the stream originally was divided in according to embodiments of the present invention.

FIG. 4 exemplifies how the segments being a shorter version of the segment that the stream originally was divided in can be created according to embodiments of the present invention.

FIG. 5 illustrates schematically one embodiment of the present invention where multiple shorter segments are provided.

FIG. 6 illustrates schematically one embodiment of the present invention.

FIG. 7 illustrates schematically one embodiment of the present invention.

FIG. 8 illustrates schematically one embodiment of the present invention.

FIGS. 9-12 are flowcharts illustrating a method according to embodiments of the present invention.

FIG. 13a illustrates schematically a network element according to embodiments of the present invention.

FIG. 13b illustrates schematically a computer according to a possible implementation of the embodiments of the present invention.

FIGS. 14-15 illustrate schematically where the embodiments can implemented.

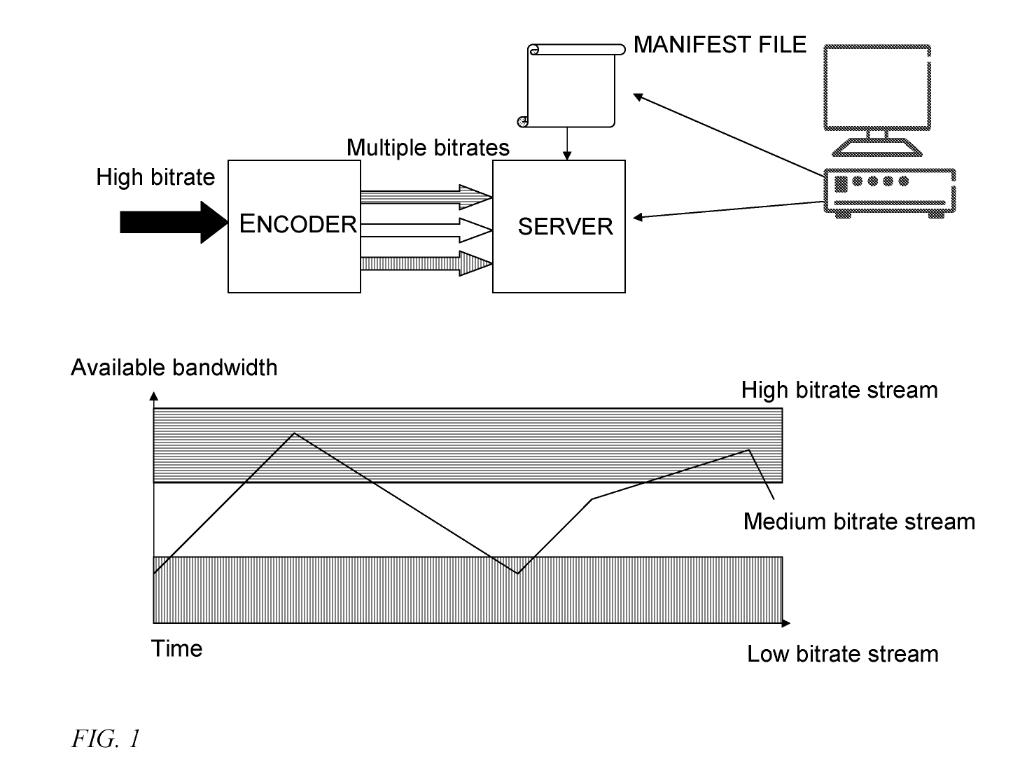

### DETAILED DESCRIPTION

Thus, an object of the embodiments is to reduce the delay during channel change. There are different kinds of delays.

In first case, the server sends the segments to the users synchronously. E.g. segment 1, 0-5 seconds, segment 2, 5-10 seconds. If a user wants to join at t=3.75 s, he has to await segment 2 at t=5 s, in order to receive a key frame, since each segment normally contains one key frame in the beginning of each segment, i.e. a delay of 1.25 s. This example may be applicable for cable TV. Hence the delay in this case relates to a zapping delay.

In a second case, there is server providing the segments when a user requests them. This scenario may be applicable to when a user A wants to watch a movie and sends a request to the server and there is basically no delay since the server can start streaming the movie to the user as soon as the request is received at ty. I.e. user A receives a segment 1 at t=ty. Another user B can request the same move at another point of time tx, and the user will be provided the movie at the another point of time tx. I.e. user B will receive segment 1 at t=tx. There will of course be a delay between the users tx-ty but that is no problem since they are watching the same movie independently of each other and the content of the movie is not live. The delay in this case relates to user-to user delay, but this delay is not relevant since the consumed content is not live content.

In a third case, the requested content is a live broadcast event, such as a football game. In this case it is important that the delay between the users is as small as possible. All users should be able to watch the same content at the same time. Using the example with a football game, you do not want to be in unsynch with your neighbor watching the same football game so you can hear him screaming over a goal, when you will watch the goal 5 seconds later. If the solution in the example above would be used for the live content streaming a user-to-user delay would be introduced. Another possibility is synchronize the segments as in the first case, that would however introduce a zapping delay of 1.25 seconds.

The object of the embodiments is to reduce the zapping delay while reducing the user-to-user delay. Accordingly, the embodiments are applicable to the third case in the context of streaming (video) and the scenario, when a user (client) wants to join a channel streamed as soon as possible. In this specification, the terms “user” and “client” are used interchangeably. The user receives the media stream via a set-top-box (the client) and can be displayed on a display connected to the set-top-box. Further it should be noted that the embodiments are applicable in the context of adaptive bitrate streaming, such as Dynamic Adaptive Streaming over HTTP

(DASH) but adaptive bitrate streaming is not a requirement for the embodiments unless explicitly stated.

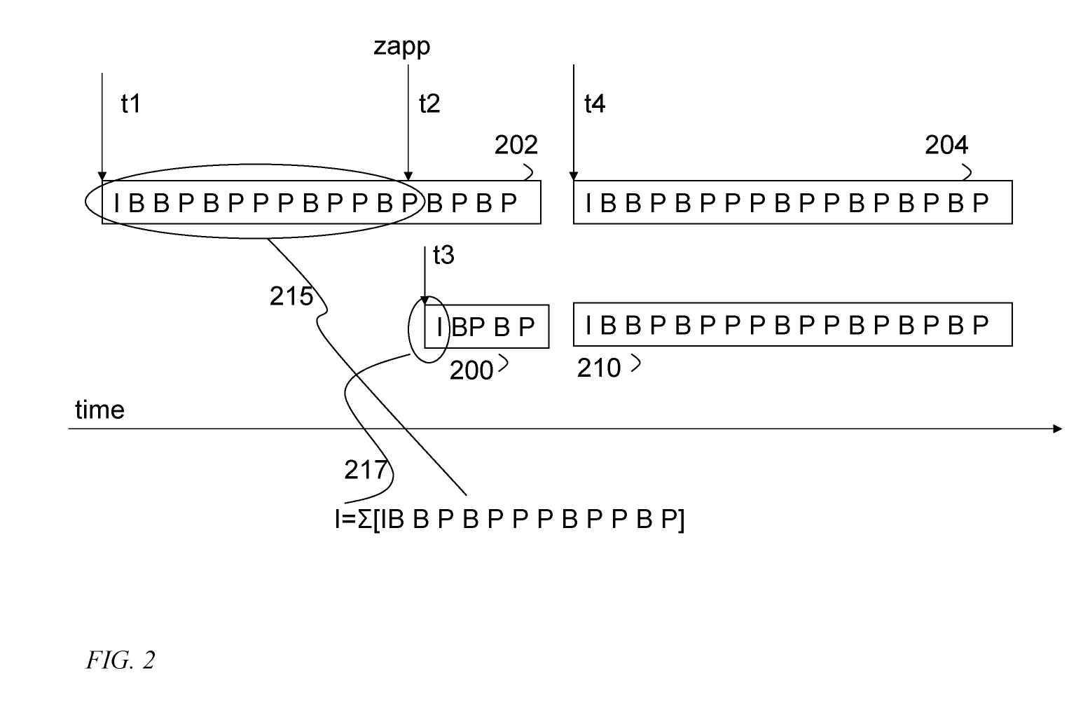

As stated above, since each segment normally is between two to ten seconds comprising one key frame in the beginning of the segment, and the users can join (i.e. zap to) a specific channel at different time instants and each user has to await an I or S frame of the segment to be able to decode the segment, the user will suffer from a zapping time delay. Further, an example which is illustrated in FIG. 2, if a first user joins the stream carrying media on channel A exactly when the most recent 10 seconds segment arrives (at t1) and a second user joins the segment carrying media on channel A when it is only 2 seconds left before the next segment arrives (at t2). The second user will have to start from the same place as the first user (t1), which implies that the second user will be 8 seconds behind and experience 8 seconds delay as long as he/she watching channel A. This gap will never be recovered, implying a user-to-user delay of 8 seconds. It should be noted that it is also possible for the second user to await the next segment (if not http streaming), but that would mean that there would be a two second zapping delay, which also is undesired. Thus the users join a first segment 202 of the stream carrying media on channel A at t1 and when the first segment 202 is consumed, a second segment 204 of the same stream will be consumed accordingly.

According to embodiments of the present invention, the user-to-user delay and the zapping delay are reduced by a network element which is configured to provide at least one segment 200 that is a shorter version of the actual segment 202 and where the shorter version of the actual segment begins with a key frame 200 or contains key frames only as illustrated in FIG. 2.

By providing the at least one segment being a shorter version of the actual segment, wherein a key frame is inserted in the beginning of the segment, the delay, when zapping to a new channel, can be reduced, since a key frame will be accessible with a reduced time delay. Further the user-to-user delay is also reduced since the segment to be joined is shorter. Hence, the time difference occurring when a first user joins in the beginning of a segment and when another user joins at the end of the segment is reduced when the segments are shorter. In addition, the length of the segments can be adjusted to the requested joining point which implies that a shorter segment is provided starting at the requested joining point in order to further reduce the user-to-user delay to substantially zero. Referring to FIG. 2, it is illustrated that the second user could be provided with a segment 200 being a shorter version of the actual segment. In this way the second user could join at the time instant denoted t3 instead of t1 or t4, which results in a user-to-user delay of zero. When the data in the segment 200 being a shorter version of the actual segment is consumed the user can then join the next actual segment 210 which is part of the stream of segments that the stream originally was divided in. By introducing the shorter segment, the possibility to join the next actual segment 210 which is part of the stream of segments that the stream originally was divided in is provided, which makes it possible to reduce the user-to-user delay, since all users will be in synch with the original stream.

In this way, “old” frames 215 of the stream to be joined are replaced with a key frame 217 such that the key frame is accessible at the joining point, which results in both a reduced zapping time delay and a reduced user-to-user delay. It should be noted that the segment being a shorter version of the segment that the stream originally was divided in is also referred to as the “shorter segment”.

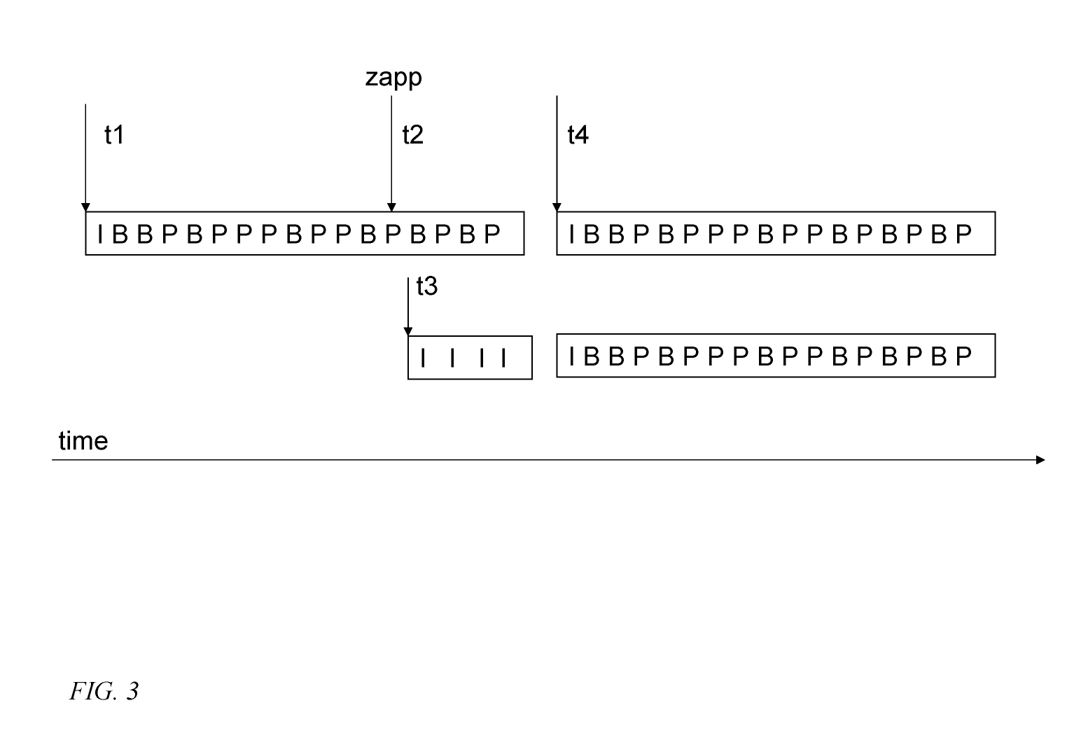

According to an embodiment, the segment being a shorter version of the actual segment may also comprise only self-contained key frames exemplified by I frames in FIG. 3.

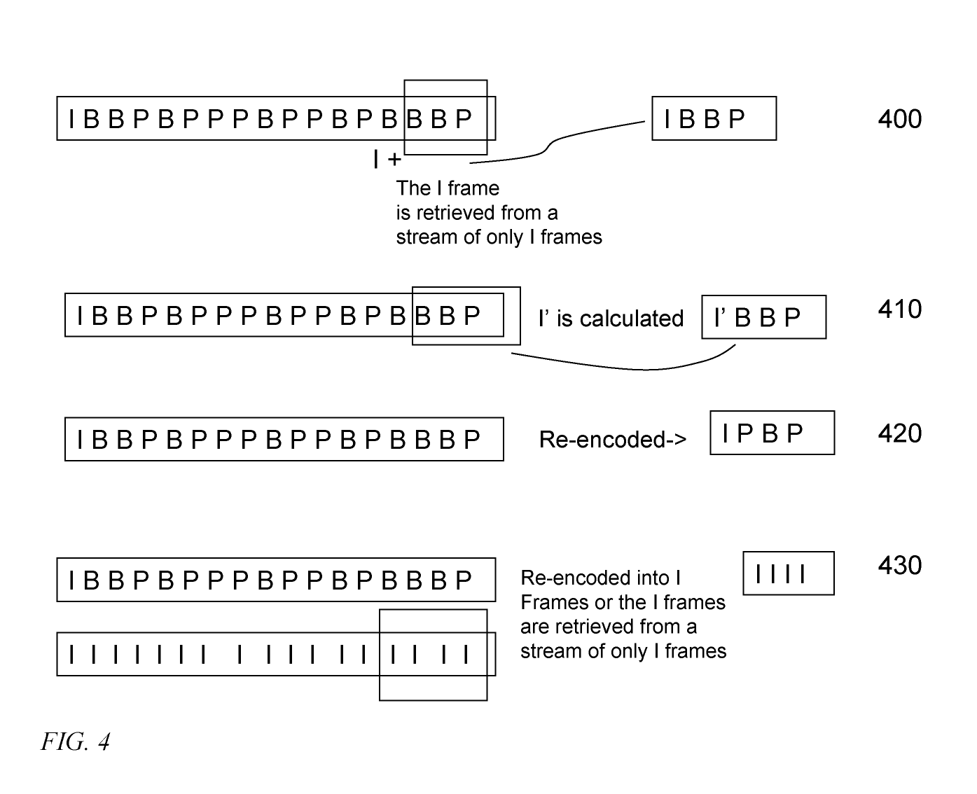

There are different ways to create the segment being a shorter version of the actual segment and some are exemplified below and in FIG. 4:

400: According to one embodiment, the actual segment is cut off to a shorter segment and a key frame is inserted in the beginning of the shorter segment. In this embodiment, the key frame to be inserted is retrieved from a pure key frame stream, i.e. a stream only comprising key frames.

Such a pure key frame stream can be constructed by an encoder. That implies that the encoder receives the media data to be encoded and in addition to the conventional encoding of the media, a pure key frame stream is also provided.

410: According to yet a further embodiment, the actual is segment is cut off where the user wants to join and a new key frame is inserted in the beginning of the shorter segment as in the embodiment described above and referred to as 400 but the new key frame is calculated based on the data contained in the part of the segment that was cut off.

420: According to another embodiment the actual segment is decoded and encoded again to a shorter segment starting with a key frame.

430: In another embodiment a segment being a shorter version of the actual segment is provided, wherein the segment contains only key frames as illustrated in FIG. 3. The key frames can either be retrieved by re encoding the actual segment to a shorter segment containing only key frames, or the key frames can be retrieved from a key frame stream comprising only key frames.

The manifest file can also be changed. The client can then determine from the manifest file that there is only one segment that is shorter and starts with e.g. 150 frames, followed by segments that are longer e.g. 600 frames.

An example how to determine the length of the shorter segments that is adapted for the joining point of the client is described below:

Assume that all clients are synchronized. That means that all clients will start downloading the first segment at time t1 in FIG. 2, and all clients will start downloading segment 2 at t4. If you are a new user that joins between t1 and t4, you want to start downloading a segment that is exactly so long (in terms of frames) that, when you are finished downloading it and it is time to start downloading the second segment, time equals t4.

One way to calculate this is the following: It is now time t3 (say t3=7.5 seconds). All clients will start downloading segment 2 at time t4=10 seconds. There is 10-7.5=2.5 seconds left. If the media data clip has a frame rate of 60 frames per second, the media data clip should consist of 60*2.5=150 frames, or (t4−t3)*fps (frames per seconds) in general.

Note that it may be advantageous to allow some margin in either direction.

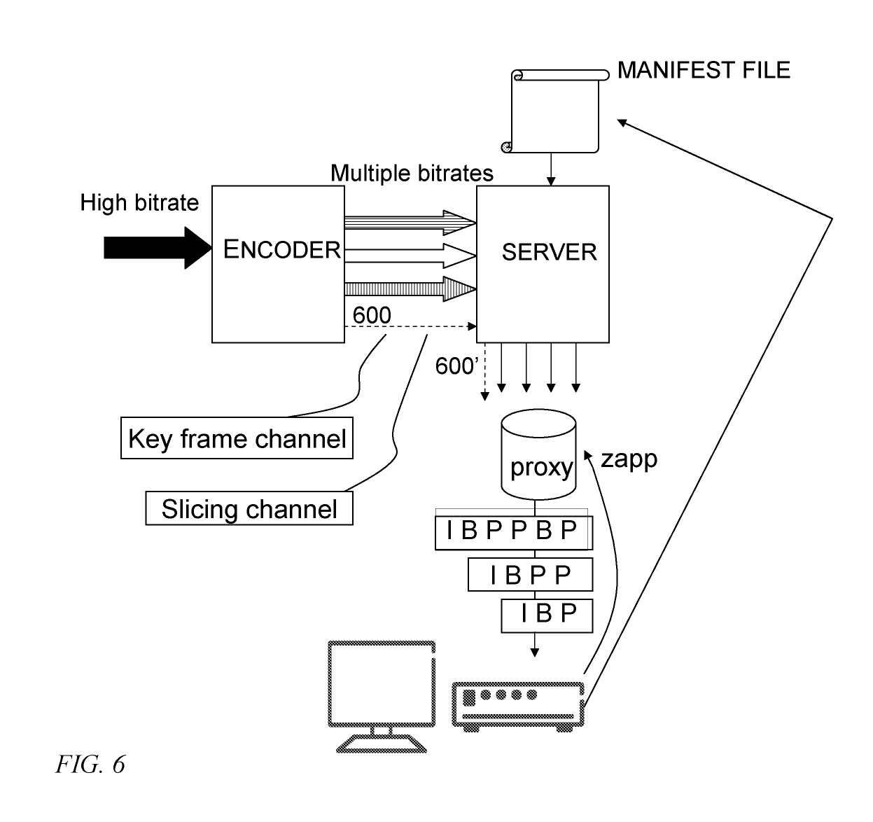

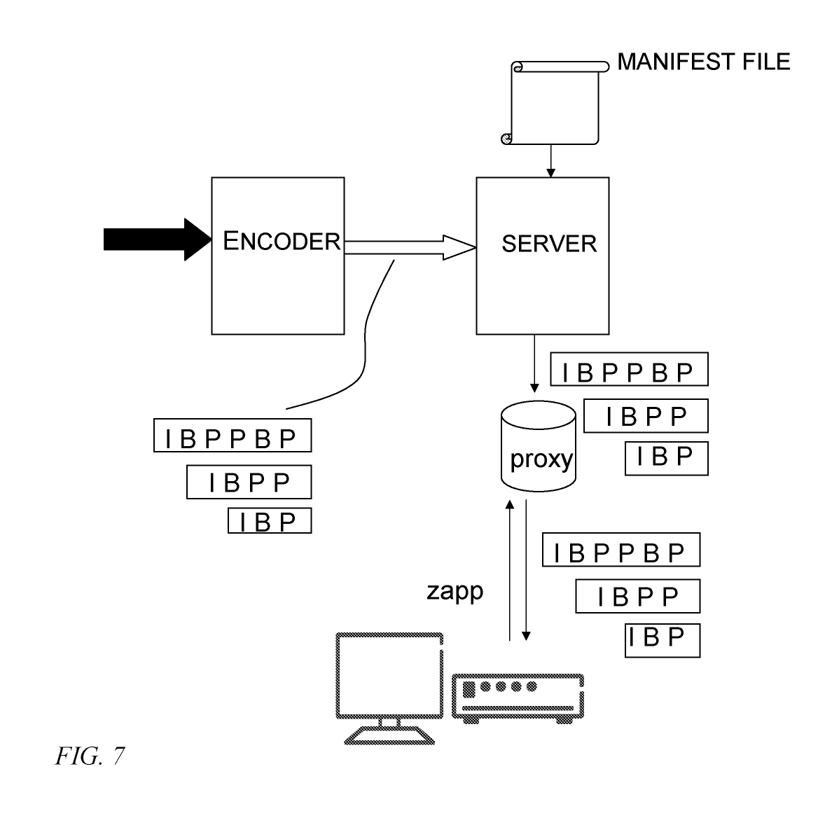

The shorter segments can either be created by the encoder (FIG. 7) or by a proxy associated with the web server (FIG. 6). The proxy can also be a part of the web server. If the shorter segments are created by the proxy, and if the key frame stream or a slicing stream (explained below) is used, the key stream or the slicing stream has to be provided by the encoder to the proxy.

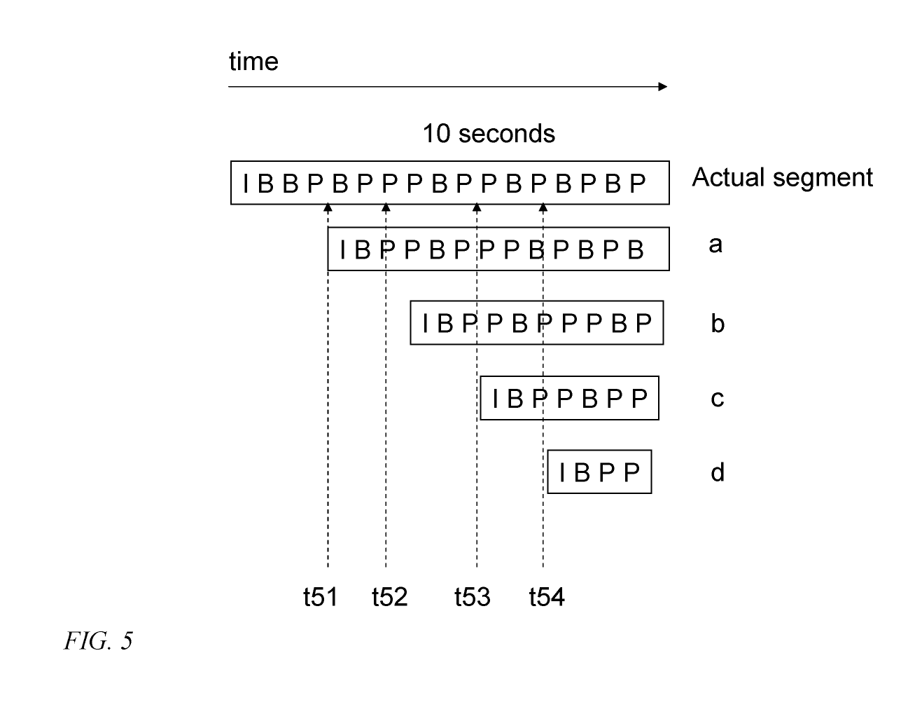

Instead of providing a shorter segment that has length adapted for the joining point, multiple versions of the segments being a shorter version of the actual segment can be provided as illustrated in FIG. 5. These multiple shorter segments have different lengths and when a user joins a new channel, the segment that gives the shortest delay should be provided by the proxy to the user. For example, a user who wants to join at t52 in FIG. 5, would have to join the stream at t51a to get the best user experience in terms of user-to-user delay, since the user-to-user delay would be zero while the zapping delay would be t52-t51b. The multiple shorter segments can be created according to any of the examples 400, 410, 420, 430 described above.

These shorter segments can either be provided by the encoder or a proxy associated with the web server. In FIG. 6, the proxy is located after the web server and the proxy creates the shorter segments. In order to alleviate for the proxy to create the shorter segments, the encoder can provide the proxy with a key frames stream or alternatively a slicing stream. The key frames stream comprises only key frames, e.g. I frames, and the slicing stream is a stream that is specifically adapted to be divided into shorter segments. I.e. in the slicing stream the self-contained key frames are created such that they imitates a non-self contained frame pixel by pixel. The key frame stream comprises self-contained key frames which not necessarily has a clear corresponding non self-contained frame.

The encoder creates the key frames stream and the slicing streams, respectively, by encoding the data to the key frames stream or the slicing stream. The slicing stream can, but is not limited to, be created by simply replacing one of the P-frames with an S-frame. The S-frame contains (almost exactly) the same pixels as the P-frame, so the following P and B frame can use the S-frame instead of the P-frame. The S-frame is self-contained, so the entire IBBPBBPBBPBBP-sequence does not have to be sent. As an example, the frame marked with I+ in 400 in FIG. 4 could be an S-frame. It is an I-frame that just encodes the same pixels as the P-frame it replaces.

As another example, the proxy comprises a transcoder and re-encodes the actual segments to one or more shorter segments being a shorter version of the segments that the stream originally was divided in as explained in 420 of FIG. 4.

In the example of FIG. 6, the encoder sends multiple adaptive bit rate streams and possibly also the key frames stream or the slicing stream. The web server receives the streams from the encoder and forwards them to the proxy. The proxy creates multiple shorter segments of the segment of one of the adaptive bit rate streams, e.g. the adaptive bit rate stream with the lowest possible bit rate adapted for the client. If the key frames stream is provided, the key frames from this stream can be used for creating the shorter segments. If the slicing stream is provided, the slicing stream can be used to create the shorter segments.

The web server may not know what happens in the proxy, it just provides regular segments to the proxy. The proxy then produces new, shorter, segments when needed as explained above. Another possibility is that the web server has already pre-calculated all the possible shorter segments that the proxy could ever need to produce. In this case the proxy would ask the web server for these shorter segments. An advantage with this solution is that the proxy does not require a transcoder.

In an alternative embodiment illustrated in FIG. 7, the encoder creates the shorter segments, e.g. by re-encode the original segments to shorter segments or according to another method as explained in conjunction with FIG. 4. Hence the encoder is configured to encode a stream with shorter segments, e.g. with a lowest possible bit rate adapted for the client in addition to e.g. the multiple adaptive bit rate streams . . .

In the case of adaptive bitrate streaming, it should be noted that it is also possible to create multiple shorter segments with different bitrates by either the encoder or the proxy.

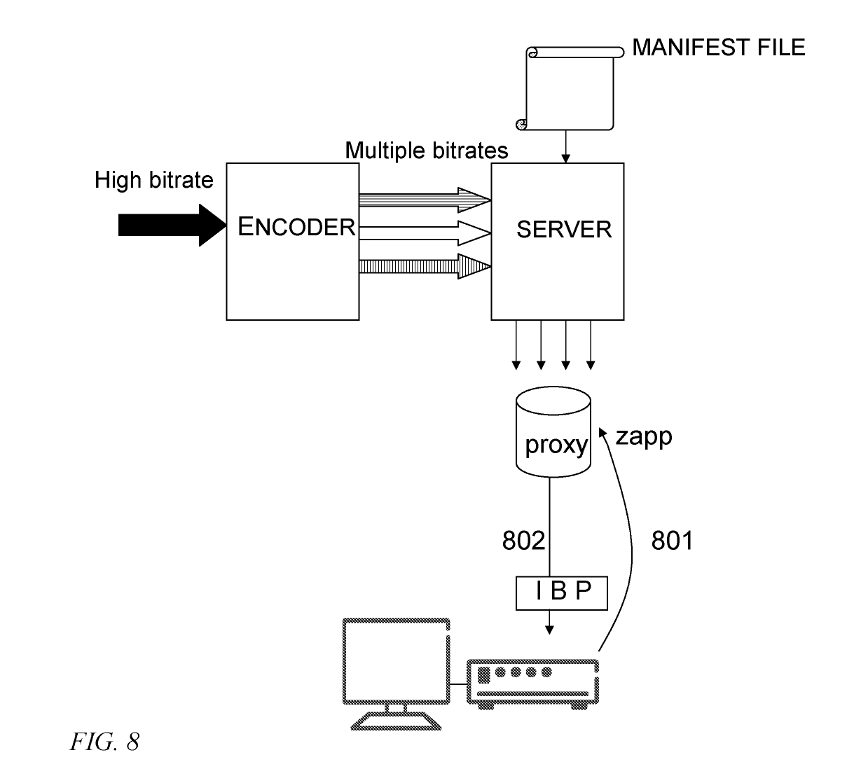

Turning to FIG. 8, showing an additional example of one embodiment of the present invention. The user watching a channel A wants to change to channel B, the set-top box signals to the proxy/server that the user wants to join channel B 801. When the proxy/server receives the channel change request of channel B, it provides 802 a shorter segment of the stream carrying channel B according to one of the alternatives described above and illustrated in FIG. 4 and when the shorter segment is consumed, it provides a subsequent segment that the stream originally was divided in.

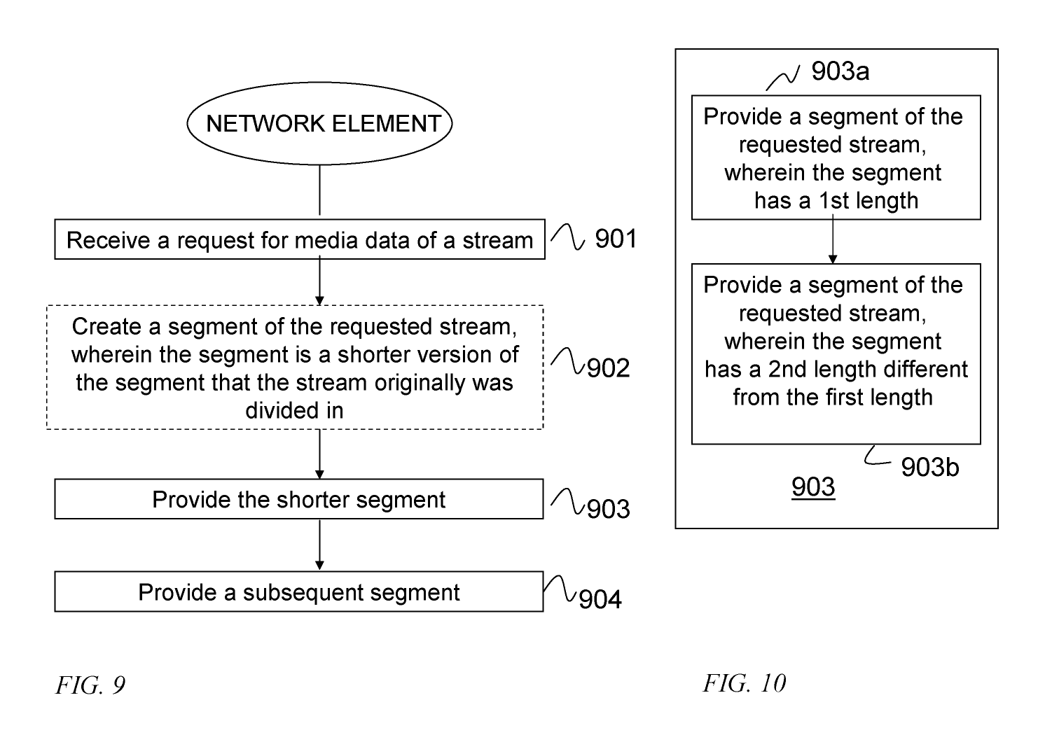

As illustrated in FIG. 9, a method to be performed by a network element for enabling streaming of media data such as video data is provided. The media data is originally divided into segments of a first length provided in a stream and the media data is represented by non self contained frames and self contained key frames in the segments. The non self contained frames can be P- and B-frames but can also relate to any other frames that require additional information to be decodable. The self contained key frames relates to any frames that can be decoded independently of other frames, such as I frames. A key frame is always self-contained.

The network element receives 901, from a client, a request for media data of a stream and the network element provides 903, to the client, a segment of the requested stream, wherein the segment is a shorter version of the segment that the stream originally was divided in and a first frame of the provided segment is a self contained key frame. When the shorter segment is consumed, it provides 904 a subsequent segment that the stream originally was divided in. In this way both the zapping delay and the user-to-user delay is reduced.

In one embodiment, the segment being a shorter version of the segment that the stream originally was divided in only comprises self contained key frames as illustrated in FIG. 3.

As mentioned above, a length of the segment being a shorter version of the segment that the stream originally was divided in is adapted to a time when the client wants to join the requested stream in order to minimize the time delay when changing to a new channel.

As illustrated in FIG. 5 and FIG. 10, the providing step 903 may further comprise providing 903a, to the client, a segment of the requested stream, wherein the segment has a first length and is a shorter version of the segment that the stream originally was divided in and a first frame of the provided segment is a self contained key frame, and providing 903b, to the client, a segment of the requested stream, wherein the segment has a second length different from the first length and is a shorter version of the segment that the stream originally was divided in and a first frame of the provided segment is a self contained key frame.

In a further embodiment, the provided segment(s), being a shorter version of the segment that the stream originally was divided in, may be provided in different bit rates. However, if the shorter segment is provided in one bitrate, that bitrate may be a low bitrate.

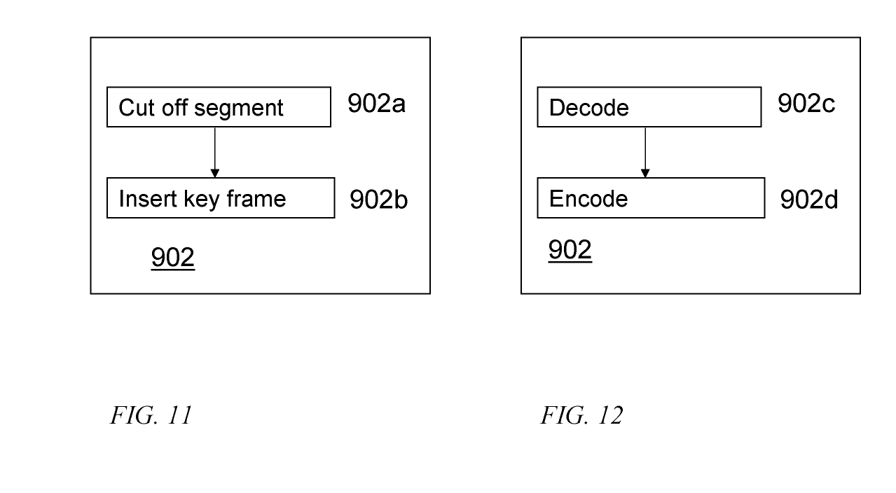

In some embodiments, the network element creates 902 the segment being a shorter version of the segment that the stream originally was divided in. That can be performed by cutting 902a off frames from the segment that the stream originally was divided in, wherein the end of the segment is being used as the segment being a shorter version, inserting 902b a new self contained key frame in the beginning of the segment being a shorter version of the segment that the stream originally was divided in. This is illustrated in FIG. 11 and FIG. 4.

As illustrated in FIG. 4 (430), according to one embodiment the new self contained key frame is created by calculating the new key frame based on frames being cut off. The new self contained key frame can also be created by retrieving a key frame from a stream of segments comprising only key frames.

With reference to FIG. 12 and FIG. 4 (420), in one embodiment the network element creates 902 the segment being a shorter version of the segment that the stream originally was divided in by decoding 902c the segment that the stream originally was divided in, and encoding 902d the decoded segment into a shorter version of the segment that the stream originally was divided in.

The network element can be an encoder receiving the media data to be encoded and providing an encoded representation of the media data in a stream divided into segments.

When the network element is an encoder it can create and send 600 a stream of segments comprising only self contained key frames to be used for creating the segment being a shorter version of the segment that the stream originally was divided in and/or a slicing stream of segments specifically adapted to be used for creating the segment being a shorter version of the segment that the stream originally was divided in as illustrated in FIG. 6.

Alternatively, the network element can be a proxy associated with a server receiving an encoded representation of the media data in a stream divided into segments from the server and configured to provide segments with media data to a client. The proxy may be included in the server.

When the network element is a proxy it can receive a stream of segments comprising only key frames to be used for creating the segment being a shorter version of the segment that the stream originally was divided in and/or receive a slicing stream of segments specifically adapted to be used for creating the segment being a shorter version of the segment that the stream originally was divided in.

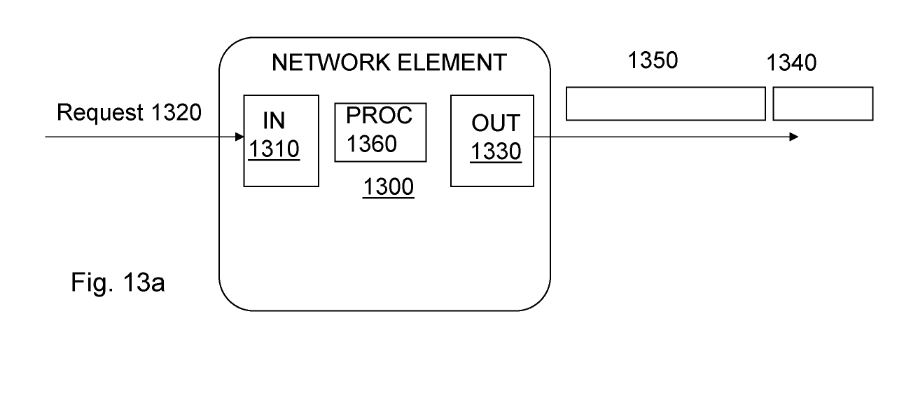

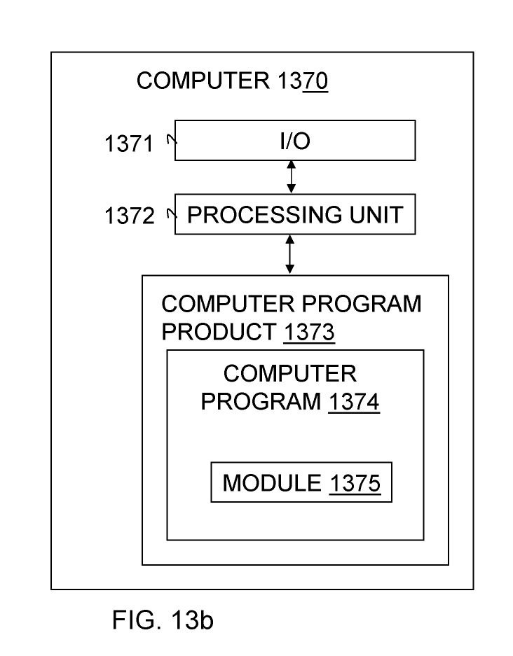

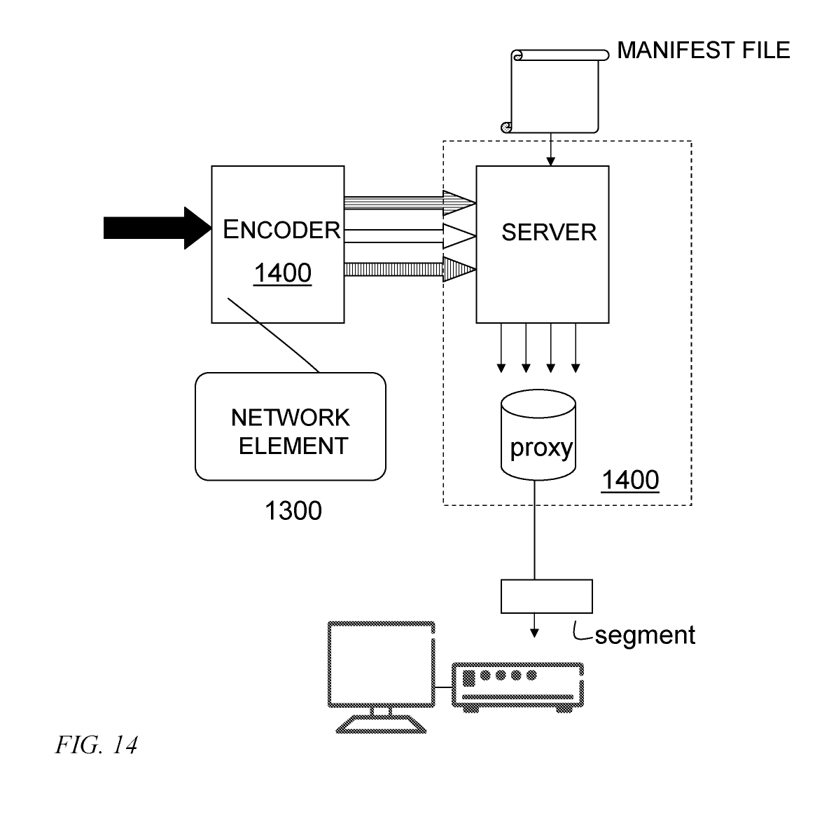

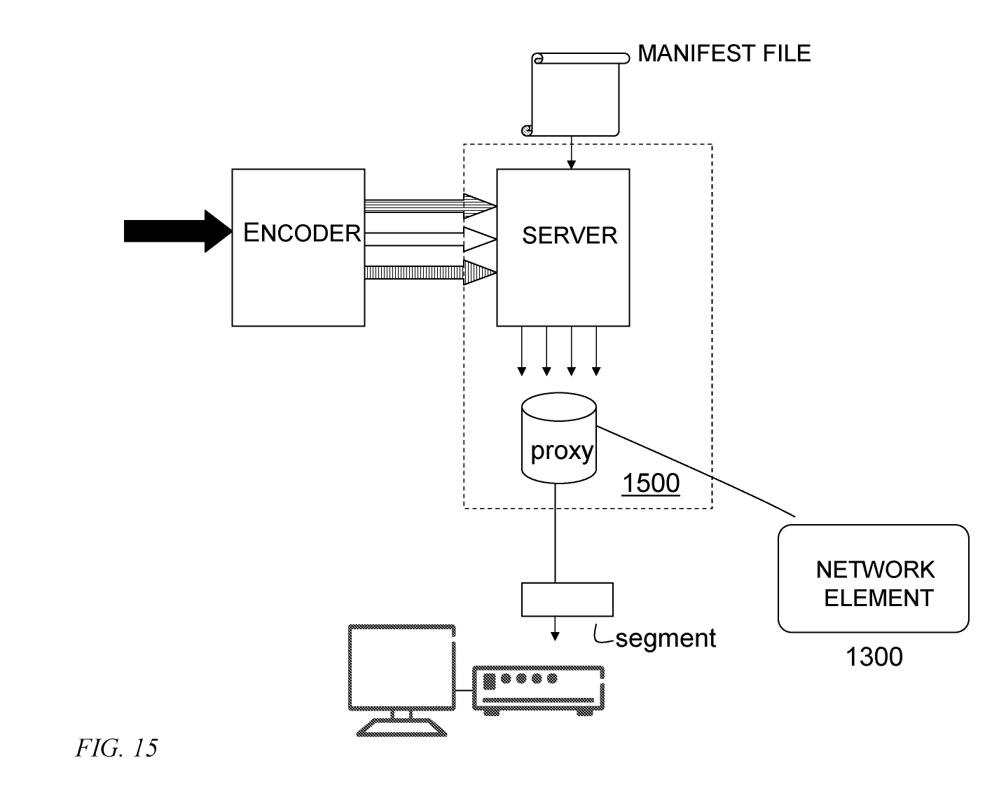

According to a further aspect of the embodiments, a network element 1300 for enabling streaming of media data is provided as illustrated in FIG. 13a. The media data is originally divided into segments of a first length provided in a stream and the media data is represented by non self contained frames and self contained key frames in the segments. The network element 1300 comprises an input unit 1310 configured to receive a request 1320 for media data of a stream (either direct from the set-top box of the user or via a server), and an output unit 1330 configured to provide a segment 1340 of the requested stream, wherein the segment is a shorter version of the segment that the stream originally was divided in and a first frame of the provided segment is a self contained key frame and configured to provide a subsequent segment 1350 of the requested stream wherein the subsequent segment is a segment that the stream originally was divided in.

According to an embodiment, the network element 1300 providing the shorter segment also creates the shorter segment. Therefore the network element 1300 comprises a processor 1360 configured to create the segment 1340 being a shorter version of the segment that the stream originally was divided in to only comprise self contained key frames. The processor 1360 may be configured to create the segment being a shorter version of the segment that the stream originally was divided in with a length that is adapted to a time when the client wants to join the requested stream.

Furthermore, multiple shorter segments can be provided. That implies that the output unit 1330 may be configured to provide a segment of the requested stream, wherein the segment has a first length and is a shorter version of the segment that the stream originally was divided in and a first frame of the provided segment is a self contained key frame, and to provide a segment of the requested stream, wherein the segment has a second length different from the first length and is a shorter version of the segment that the stream originally was divided in and a first frame of the provided segment is a self contained key frame.

As mentioned above, the shorter segments can be created in various ways. Hence, the processor 1360 may be configured to create the segment being a shorter version of the segment that the stream originally was divided in by cutting off frames from the segment that the stream originally was divided in, wherein the end of the segment is being used as the segment being a shorter version, and to insert a new self contained key frame in the beginning of the segment being a shorter version of the segment that the stream originally was divided in.

Further, the processor 1360 may be configured to insert the new self contained key frame by calculating the new key frame based on frames being cut off. E.g., the processor 1360 is configured to insert the new self contained key frame by retrieving a key frame from a stream of segments comprising only key frames.

In some embodiments, the network element that provides the shorter segment also creates the shorter segment. In one case, the processor is configured to create the segment being a shorter version of the segment that the stream originally was divided in by decoding the segment that the stream originally was divided in, and encoding the decoded segment into a shorter version of the segment that the stream originally was divided in. That can be done in the encoder or in the proxy. If it is done in the proxy, the proxy comprises a transcoder for performing the encoding and decoding. The transcoder can be implemented by a processor.

Thus, the network element can be an encoder configured to receive the media data to be encoded and to provide an encoded representation of the media data in a stream divided into segments.

This entity is referred to as encoder, since the main purpose is to encode the bitstream of the media data to a representation that is compressed to be better suitable for transmission. However, the encoder also has other capabilities in addition to the functionalities relating to the embodiments of the present invention.

When the network element is an encoder, the processor may be configured to create a stream of segments comprising only self contained key frames to be used for creating the segment being a shorter version of the segment that the stream originally was divided in and/or configured to create a slicing stream of segments specifically adapted to be used for creating the segment being a shorter version of the segment that the stream originally was divided in.

As mentioned above, the network element may be a proxy. The proxy is associated with a server from which the proxy receives the encoded representation of the media data. As an example the proxy may be included in the server that it is associated with. Accordingly, the proxy is configured to receive an encoded representation of the media data in a stream divided into segments from the server and configured to provide segments with media data to a client.

According to an embodiment, the input unit is further configured to receive a stream of segments comprising only key frames to be used for creating the segment being a shorter version of the segment that the stream originally was divided in. This stream of segments can be received from the encoder.

In another embodiment, the input unit is further configured to receive a slicing stream of segments specifically adapted to be used for creating the segment being a shorter version of the segment that the stream originally was divided in. This slicing stream can be received from the encoder.

The network element with its including units could be implemented in hardware. There are numerous variants of circuitry elements that can be used and combined to achieve the functions of the units of the network element. Such variants are encompassed by the embodiments. Particular examples of hardware implementation of the network element are implementation in digital signal processor (DSP) hardware and integrated circuit technology, including both general-purpose electronic circuitry and application-specific circuitry.

The network element described herein could alternatively be implemented e.g. by one or more of a processing unit and adequate software with suitable storage or memory therefore, a programmable logic device (PLD) or other electronic component(s) as shown in FIG. 13b.

FIG. 13b schematically illustrates an embodiment of a computer 1370 having a processing unit 1372, such as a DSP (Digital Signal Processor) or CPU (Central Processing Unit). The processing unit 1372 can be a single unit or a plurality of units for performing different steps of the method described herein. The computer 1370 also comprises an input/output (I/O) unit 1371 for receiving recorded or generated video frames or encoded video frames and outputting the shorter segments. The I/O unit 1371 has been illustrated as a single unit in FIG. 13b but can likewise be in the form of a separate input unit and a separate output unit.

Furthermore, the computer 1370 comprises at least one computer program product 1373 in the form of a non-volatile memory, for instance an EEPROM (Electrically Erasable Programmable Read-Only Memory), a flash memory or a disk drive. The computer program product 1373 comprises a computer program 1374, which comprises code means which when run on or executed by the computer, such as by the processing unit, causes the computer to perform the steps of the method described in the foregoing in connection with FIGS. 9-12. Hence, in an embodiment the code means in the computer program comprises a module 1375 configured to implement embodiments as disclosed herein or combinations thereof. This module 1375 essentially performs the steps of the flow diagrams in FIGS. 9-12 when run on the processing unit 1372. Thus, when the module 1375 is run on the processing unit 1372 it corresponds to the corresponding units of FIG. 13a.

1-18. (canceled)

19. A method performed by a network element, for enabling live streaming of media data, wherein the media data is originally divided into segments of a first length provided in a stream and the media data is represented by non-self-contained frames and self-contained key frames in the segments, the method comprising:
receiving, from a client, a request for media data of a stream,
providing, to the client, in response to said request, a segment of the requested stream, wherein the segment is a shorter version of the segment that the stream originally was divided in and a first frame of the provided segment is a self-contained key frame, and
providing, to the client, a subsequent segment of the requested stream wherein the subsequent segment is a segment that the stream originally was divided in.

20. The method according to claim 19, wherein a length of the segment being a shorter version of the segment that the stream originally was divided in is adapted to a time when the client wants to join the requested stream.

21. The method according to claim 19, further comprising
providing, to the client, a segment of the requested stream, wherein the segment has a first length and is a shorter version of the segment that the stream originally was divided in and a first frame of the provided segment is a self-contained key frame, and
providing, to the client, a segment of the requested stream, wherein the segment has a second length different from the first length and is a shorter version of the segment that the stream originally was divided in and a first frame of the provided segment is a self-contained key frame.

22. The method according to claim 19, wherein the method comprises the further steps of:
creating the segment being a shorter version of the segment that the stream originally was divided in by:
cutting off frames from the segment that the stream originally was divided in, wherein the end of the segment is being used as the segment being a shorter version,
inserting a new self-contained key frame in the beginning of the segment being a shorter version of the segment that the stream originally was divided in.

23. The method according to claim 19, wherein the network element is an encoder receiving the media data to be encoded and providing an encoded representation of the media data in a stream divided into segments.

24. The method according to claim 19, wherein the network element is a proxy receiving an encoded representation of the media data in a stream divided into segments from a server and configured to provide segments with media data to a client.

25. The method according to claim 24, further comprising
receiving a slicing stream of segments specifically adapted to be used for creating the segment being a shorter version of the segment that the stream originally was divided in.

26. A network element for enabling live streaming of media data, wherein the media data is originally divided into segments of a first length provided in a stream and the media data is represented by non-self-contained frames and self-contained key frames in the segments, the network element comprising:
an input unit configured to receive a request for media data of a stream; and
an output unit configured to provide a segment of the requested stream in response to said request, wherein the segment is a shorter version of the segment that the stream originally was divided in and a first frame of the provided segment is a self-contained key frame, and further configured to provide a subsequent segment of the requested stream, wherein the subsequent segment is a segment that the stream originally was divided in.

27. The network element according to claim 26, wherein the network element comprises a processor configured to create the segment being a shorter version of the segment that the stream originally was divided in with a length that is adapted to a time when the client wants to join the requested stream.

28. The network element according to claim 26, wherein the output unit is further configured to provide a segment of the requested stream, wherein the segment has a first length and is a shorter version of the segment that the stream originally was divided in and a first frame of the provided segment is a self-contained key frame, and to provide a segment of the requested stream, wherein the segment has a second length different from the first length and is a shorter version of the segment that the stream originally was divided in and a first frame of the provided segment is a self-contained key frame.

29. The network element method according to claim 26, wherein the processor is further configured to create the segment being a shorter version of the segment that the stream originally was divided in by decoding the segment that the stream originally was divided in, and encoding the decoded segment into a shorter version of the segment that the stream originally was divided in.

30. The network element according to claim 26, wherein the network element is an encoder configured to receive the media data to be encoded and to provide an encoded representation of the media data in a stream divided into segments.

31. The network element according to claim 30, wherein the processor is further configured to create a slicing stream of segments specifically adapted to be used for creating the segment being a shorter version of the segment that the stream originally was divided in.

32. The network element according to claim 26, wherein the network element is a proxy configured to receive an encoded representation of the media data in a stream divided into segments from a server and configured to provide segments with media data to a client.

33. The network element according to claim 32, wherein the input unit is further configured to receive a stream of segments comprising only key frames to be used for creating the segment being a shorter version of the segment that the stream originally was divided in.

34. The network element according to claim 32, wherein the input unit is further configured to receive a slicing stream of segments specifically adapted to be used for creating the segment being a shorter version of the segment that the stream originally was divided in.

35. A non-transitory computer-readable medium storing a computer program comprising program instructions that, when executed by a processor of a network element, enables live streaming of media data by the network element, wherein the media data is originally divided into segments of a first length provided in a stream and the media data is represented by non-self-contained frames and self-contained key frames in the segments, the computer program comprising program instructions configuring the network element to, in response to receiving, from a client, a request for media data of a stream:
provide, to the client in response to said request, a segment of the requested stream, wherein the segment is a shorter version of the segment that the stream originally was divided in and a first frame of the provided segment is a self-contained key frame, and
provide, to the client, a subsequent segment of the requested stream wherein the subsequent segment is a segment that the stream originally was divided in.

36. A method performed by a network node comprising:
receiving a request from a client to join a media stream that is streamed in successive segments, each segment having a defined length and beginning with a self-contained key frame necessary for decoding the segment, said request received during streaming of a current segment of the media stream; and
in response to the request, joining the client to the media stream by:
providing a shortened segment to the client that represents a remaining portion of the current segment relative to receipt of the request and begins with a new self-contained key frame, to enable decoding of the shortened segment at the client; and
thereafter providing subsequent ones of the successive segments of the media stream, following the current segment.
